(19) United States
(12) Patent Application Publication
(10) Pub. No.: US 2024/0183616 A1
(43) Pub. Date: Jun. 6, 2024

(54) SCRAP METAL PUSH GATE ASSEMBLY

(71) Applicant: GPRE IP, LLC, St. Louis, MO (US)

(72) Inventor: John M. Peterman, Troy, MO (US)

(73) Assignee: GPRE IP, LLC, St. Louis, MO (US)

(21) Appl. No.: 18/529,100

(22) Filed: Dec. 5, 2023

Related U.S. Application Data
(60) Provisional application No. 63/430,222, filed on Dec. 5, 2022.

(51) Int. Cl. F27D 3/00; F27B 3/04; F27D 19/00

(52) U.S. Cl. CPC F27D 3/003; F27B 3/045; F27D 19/00; F27D 2019/0059

(57) ABSTRACT

A push gate for a scrap metal furnace with a volatizing chamber and a doorway into that chamber. The push gate includes a door plate to seal against the doorway, a scoop sized to fit in the volatizing chamber, and a plunger attached to the scoop that extends through the door plate. The push gate is movable. When the push gate is positioned such that the door plate seals against the doorway, the plunger can controllably move the scoop in and out of the chamber to push scrap metal to predetermined positions in the chamber for predetermined periods of time.

### CROSS REFERENCE TO RELATED APPLICATIONS

This application derives and claims priority from U.S. provisional application 63/430,222, filed Dec. 5, 2022, and having Attorney Docket No. GILP H007US, which provisional application is incorporated herein by reference.

### STATEMENT REGARDING FEDERALLY SPONSORED RESEARCH OR DEVELOPMENT

Not applicable.

### BACKGROUND OF THE INVENTION

This invention relates principally to an apparatus for remotely pushing scrap metal positioned in the body of a scrap metal recycling furnace, and more particularly to an apparatus for the controlled and timed urging of coated scrap aluminum from the gate to the melt creek in a coated scrap melt furnace.

It has for some time been a standard practice to recycle scrap metals, and in particular scrap aluminum. Various furnace and kiln systems exist that are designed to recycle and recover aluminum from various sources of scrap, such as used beverage cans (“UBC”), siding, windows and door frames, etc. One of the first steps in these processes is to use a kiln to volatize and remove the paints, oils, and other surface materials (i.e., volatile organic compounds or “VOC's”) on the coated scrap aluminum (i.e. “feed material”). This is commonly known in the industry as “delacquering.” Delacquering is typically performed in a chamber with an atmosphere having reduced Oxygen levels and with temperatures in excess of 900 degrees Fahrenheit. However, the temperature range at which the paints and oils and other surface materials are released from the aluminum scrap in the form of unburned volatile gases typically ranges between 450 and 600 degrees Fahrenheit, which is generally known as the “volatilization point” or “VOL.” Due to variations in heat distributions across the volatizing zones and throughout scrap loads in various furnaces, the volatizing or volatizing chamber in such furnaces may be run as hot as 900 degrees Fahrenheit to ensure that sufficient heat is transferred throughout the scrap load to achieve an internal temperature of at least 450 degrees Fahrenheit.

In various such metal recycling systems, the furnace comprises multiple compartments or chambers to accommodate serial steps in the recycle process. For example, for aluminum scrap that is coated with paints and various other surface materials, it is typical to remove such coatings from the scrap aluminum before the aluminum is actually melted. Thus, in a simplistic model, such an aluminum recycle system will require at least two chambers—one for delacquering (i.e., “volatizing chamber”) and at least one for actual melt (i.e., “melt chamber”) purposes. In at least one version of such a furnace, after delacquering, the volatized scrap metal becomes part of a melt flow that circulates between the volatizing and melt chambers. This allows new (i.e., recently volatized) scrap aluminum to be placed in the melt flow and melted, while previously melted scrap can be siphoned off from the same recirculating melt flow.

One of the difficulties encountered in operating a delacquering recycle furnace is loading, moving, and indexing the scrap through the furnace in a timely and efficient manner. That is, the scrap must first be loaded into the volatilizing chamber and then processed in one or more zones of the volatilizing chamber of the furnace for desired periods of time to allow the volatiles to sufficiently extricate from the scrap before the scrap is moved or indexed into the molten metal flow for the melt chamber(s). In a traditional furnace configuration, the furnace gate must be opened to load or charge fresh, unprocessed scrap into the volatilizing chamber from a charging machine or apparatus. The new or fresh unprocessed scrap is then used to push the scrap already positioned in the volatilizing chamber through the various zones in the volatilizing chamber and then push it into the furnace's molten metal flow. In order to meet production rates, the scrap charge machine must timely insert and deliver a predetermined amount of new or fresh (i.e., unprocessed) scrap to the volatilizing chamber so as to displace the existing processed scrap by equivalent amounts. However, using unprocessed scrap to push the processed scrap is time-consuming, imprecise, and very cumbersome. For example, a common problem with this type of charging is “slugging” of the molten metal flow in the furnace, in which the entire new charge volume too quickly displaces the processed scrap by the same amount entering the metal flow, causing a rapid drop in the molten metal temperature in the metal flow. Such a rapid decrease in the molten metal temperature will slow the furnace's melt and production rates and require additional energy to recover the molten metal temperature. Further, if the volatilized scrap is pushed into the melt flow before adequate time in the volatilizing chamber, the metal can clump and clog the melt flow and otherwise adversely disrupt the melting process in addition to a rapid temperature drop in the melt flow temperature.

In addition, opening the gate exposes the furnace to outside cool air and oxygen that adversely impacts and delays the delacquering (volatizing) and melt processes in the furnace, and requires accommodations to capture the furnace fumes that escape the furnace during such procedures. Unfortunately, in a traditional melt furnace, for practical purposes the gate is often left open for extended periods of time as the new scrap is manipulated to push the scrap in the volatizing zones further into the furnace.

It would therefore be desirable to have an apparatus or system for an aluminum delacquering and melt furnace that could controllably move and/or index the scrap aluminum in the volatizing chamber, and on to the molten metal flow for the melt chamber(s), at predictable and controllable time(s) without re-opening the furnace gate, while allowing for a clean and ready hearth charge area for rapid and easy charging of the aluminum scrap. As will become evident in this disclosure, the present invention provides such benefits over the existing art.

### BRIEF DESCRIPTION OF THE DRAWINGS

The illustrative embodiments of the present invention are shown in the following drawings which form a part of the specification:

FIG. 1 is a side perspective cross-sectional view of a representative scrap aluminum melt furnace with a volatizing chamber;

FIG. 2 is a partially diagrammatic cross-sectional plan view of the scrap aluminum melt furnace of FIG. 1;

FIG. 3 is a top cross-sectional top view of the scrap aluminum melt furnace of FIG. 1;

FIG. 4 is a perspective view of a scrap metal push gate assembly incorporating a first representative embodiment of the present invention positioned proximate and facing a doorway opening into the volatizing chamber of the scrap aluminum recycling furnace of FIG. 1, with only a portion of the furnace being depicted and the gate assembly scoop positioned proximate the gate assembly door plate, the assembly carriage being pushed against the door plate being attached to the furnace doorway.

FIG. 5 is a cross-sectional side view of the scrap metal push gate assembly and associated furnace portion of FIG. 4.

FIG. 6 is a cross-sectional top view of the scrap metal push gate assembly and associated furnace portion of FIG. 4.

FIG. 7 is a rear view of the scrap metal push gate assembly and associated furnace portion of FIG. 4.

FIG. 8 is a cross-sectional top view of the scrap metal push gate assembly and associated furnace portion of FIG. 4, with the gate assembly scoop separated from the gate assembly door plate and extended partway into the furnace volatizing chamber.

FIG. 9 is a cross-sectional side view of the scrap metal push gate assembly and associated furnace portion of FIG. 8.

FIG. 10 is a cross-sectional top view of the scrap metal push gate assembly and associated furnace portion of FIG. 4, with the gate assembly scoop separated from the gate assembly door plate and fully extended into the furnace volatizing chamber.

FIG. 11 is a cross-sectional side view of the scrap metal push gate assembly and associated furnace portion of FIG. 10.

FIG. 12 is a cross-sectional top view of the scrap metal push gate assembly and associated furnace portion of FIG. 4, with the assembly door plate detached from, and the assembly carriage pulled away from, the furnace doorway.

FIG. 13 is a cross-sectional side view of the scrap metal push gate assembly and associated furnace portion of FIG. 12.

FIG. 14 is a cross-sectional top view of the scrap metal push gate assembly and associated furnace portion of FIG. 4, with the assembly shifted laterally away from the furnace doorway.

FIG. 15 is a rear view of the scrap metal push gate assembly and associated furnace portion of FIG. 14.

FIG. 16 is a perspective view of the scrap metal push gate assembly and associated furnace portion of FIG. 4, with the assembly shifted laterally away from the furnace doorway.

FIG. 17 is an alternate perspective view of the scrap metal push gate assembly and associated furnace portion of FIG. 16.

FIG. 18 is a graph showing a characteristic scrap push profile for a scrap metal push gate, such as depicted in FIG. 4, in distance over time.

FIG. 19 is a flowchart showing a representative process flow for pushing scrap through a delacquering furnace, such as the furnace of FIG. 1, by a scrap metal push gate, such as depicted in FIG. 4.

Corresponding reference characters indicate corresponding parts throughout the several views of the drawings.

### DETAILED DESCRIPTION

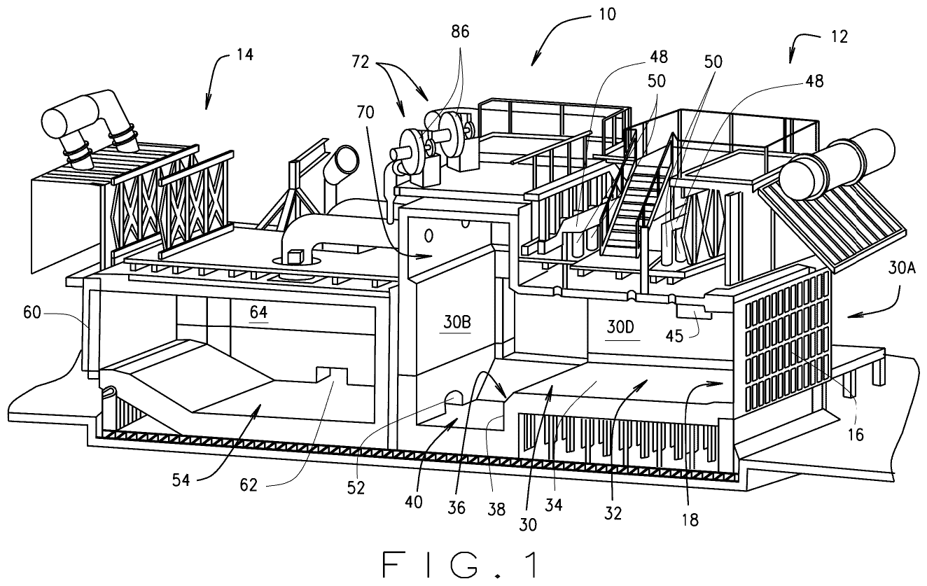

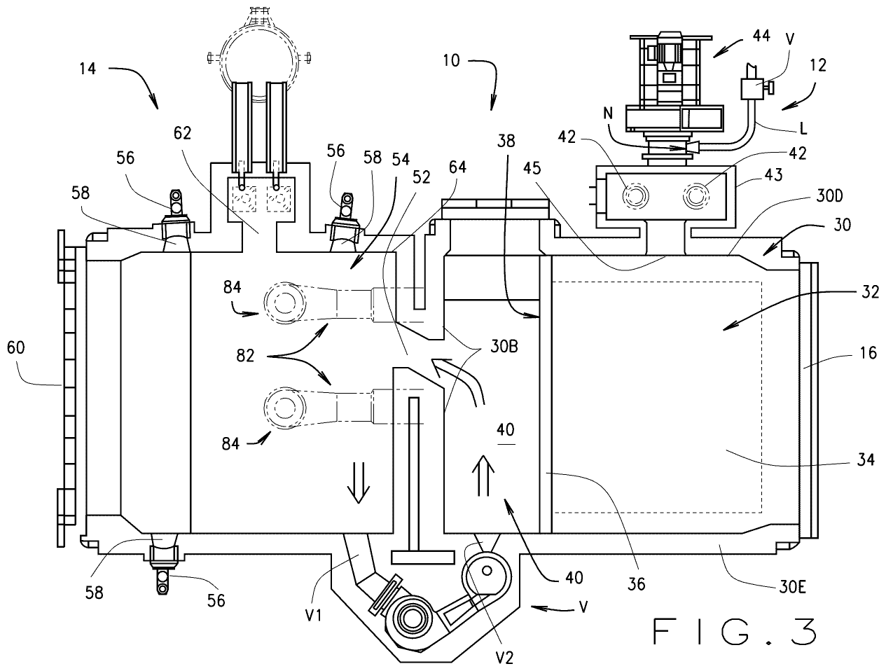

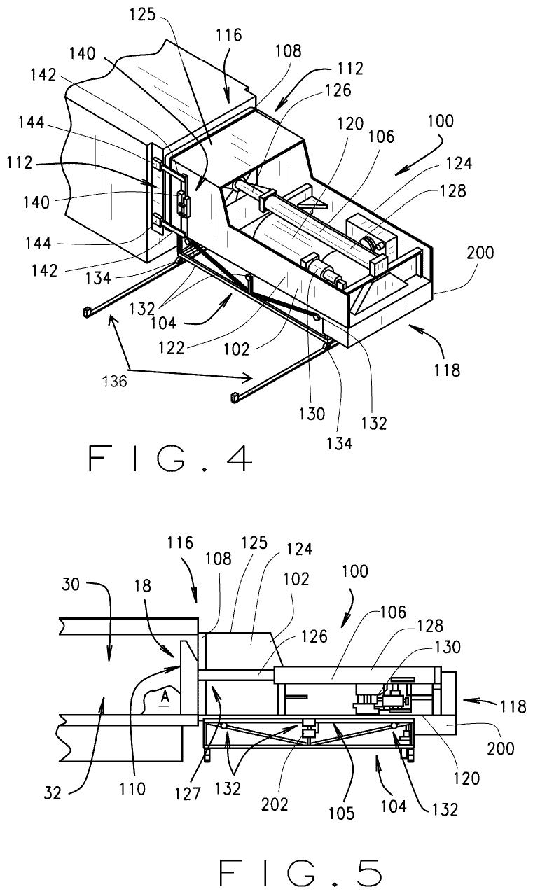

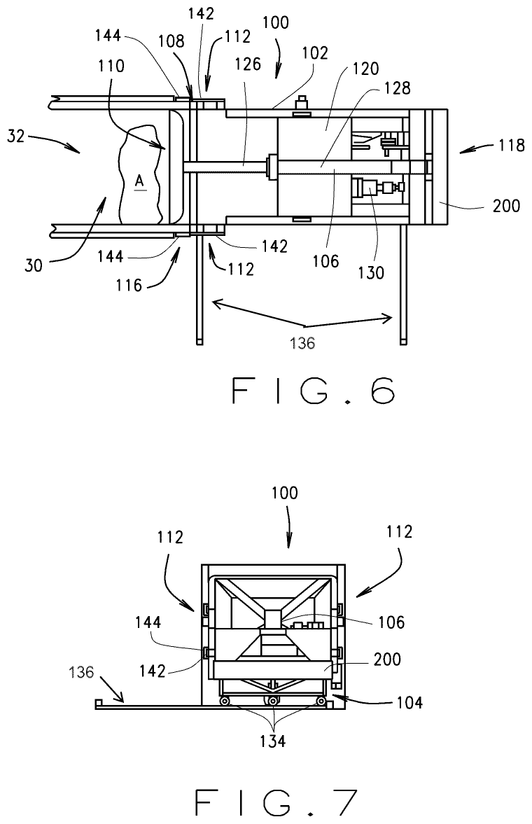

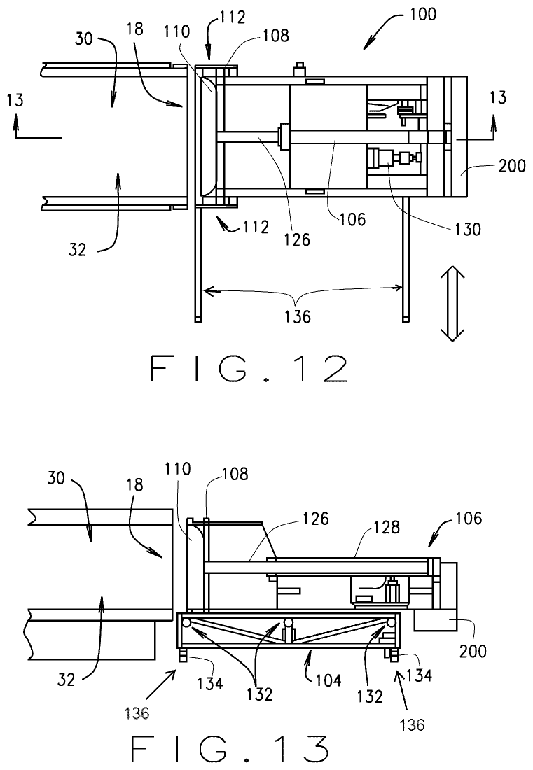

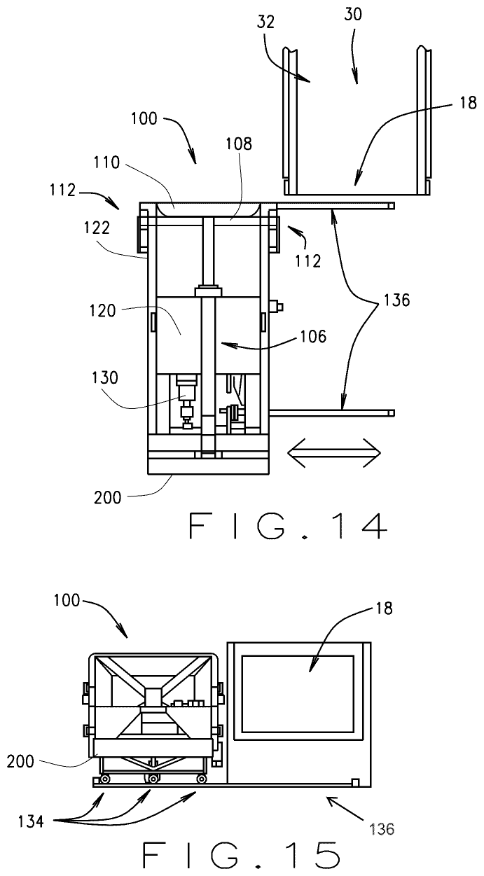

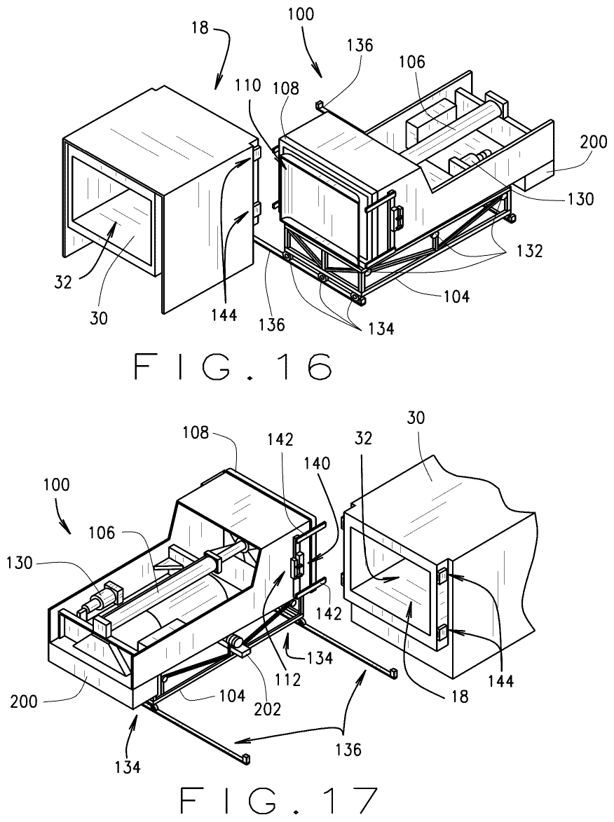

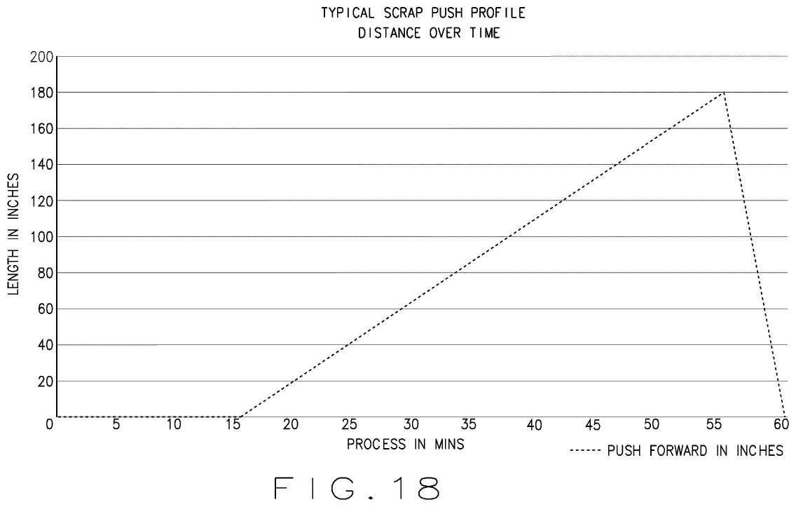

In referring to the drawings, an embodiment of a representative scrap aluminum delacquering and melt furnace 10 without a push gate assembly of the present disclosure is shown generally in FIGS. 1-3. A representative embodiment of the novel scrap metal push gate assembly 100 of the present invention is depicted by way of example in association with portions of the furnace 10 in FIGS. 4-17.

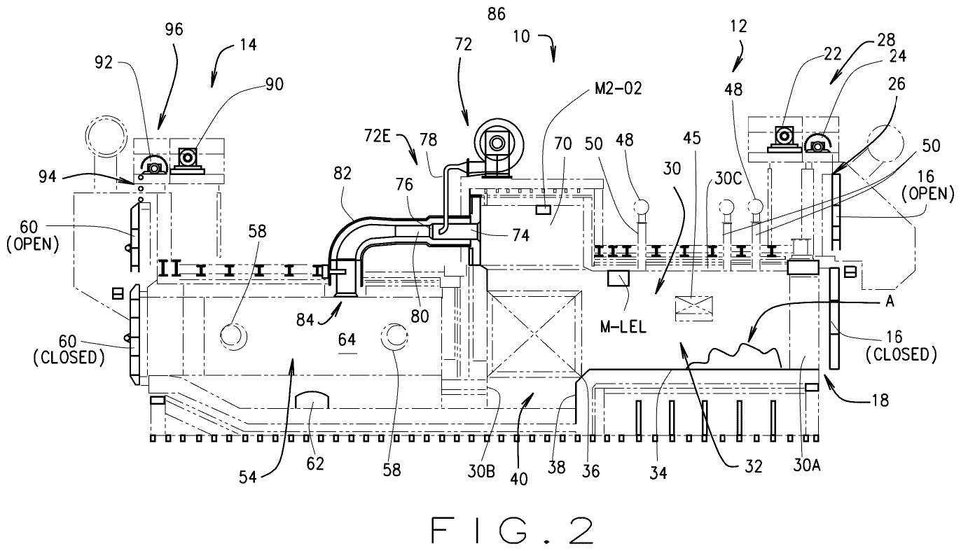

As can be seen in FIGS. 1-3, the furnace 10 has a front end 12 and a back end 14 opposite the front end 12. A vertical, rectangular steel gate or door 16 is positioned, when closed, against a doorway 18 in the front end 12 of the furnace 10. The door 16 is approximately twenty-five feet wide, ten feet tall, and one foot thick across its waffle-bracing. An electric lift motor 22 and associated lift gears 24, are positioned above the door 16 atop the front end of the furnace 10. A set of heavy chains 26 attach at one end to the top of the door 16 and attach at the other end to the lift gears 24. The motor 22, lift gears 24 and chains 26 collectively form an opening system 28 for the door 16. A computer control system CCS (not shown) for the furnace 10 operatively communicates with the opening system 28 to controllably raise and lower the door 16 between its closed position (as depicted in FIG. 1 and denoted in FIG. 2 as “CLOSED”), in which the door 16 rests against and seals the doorway 18, and its open position in which the door 16 fully exposes the doorway 18 (as depicted and denoted in FIG. 2 as “OPEN”).

The doorway 18 opens into a large, generally rectangular delacquering or volatizing chamber 30 constructed of steel and various refractory materials. The volatizing chamber 30 has a vertical front wall 30A having dimensions of approximately 9 foot high by 24 foot wide, a vertical rear wall 30B opposite the front wall 30A and having dimensions of approximately 16 foot high by 24 foot wide, a horizontal ceiling 30C having dimensions of approximately 31 foot deep by 24 foot wide, a first vertical sidewall 30D having dimensions of approximately 9 foot high by 31 foot wide, and a second vertical sidewall 30E opposite the sidewall 30D, and likewise having dimensions of approximately 9 foot high by 31 foot wide. The front wall 30A includes the doorway 18 and the gate 16.

The volatizing chamber 30 further has a delacquering or volatizing zone 32 that is approximately twenty feet wide by ten feet tall, and extends approximately twenty feet into the chamber 30 from the doorway 18. For processing purposes, the volatizing zone 32 is viewed as having a series of subzones (not shown) that extend from the doorway 18 into and to the end of the volatizing chamber 30. The exact location and positioning of these subzones can vary along the length of the volatizing zone 32 depending on the furnace configuration, the material being processed, and the process itself.

The volatizing zone 32 has a relatively flat floor 34 that extends at a slight incline downward from the doorway 18 to a one-foot wide beveled lip 36 that crosses the far end of the floor 34 opposite the doorway 18. Scrap aluminum A is loaded through the doorway 18 onto the floor 34 for initial processing in the chamber 30. The lip 36 slopes downward from the floor 34 at an angle of approximately 45 degrees to a vertical wall 38 that forms the front end of a depressed, generally rectangular pit, known as a “creek bed” 40, that runs across the end of the volatizing chamber 30. The creek bed 40 is approximately three feet deep, twenty feet long and ten feet wide. The creek bed 40 terminates at the vertical rear wall 30B.

Referring to FIG. 3, it can be seen that a set of gas burners 42, associated with a hot gas generator 43, and a recirculation burner fan 44, are positioned outside the volatizing chamber 30 adjacent the vertical sidewall 30D. The gas burners 42 are positioned on top of, and extend partially into, the hot gas generator 43, such that the heat generated by the gas burners 42 is directed downward into the hot gas generator 43. The recirculation fan 44 draws gases from the volatizing chamber 30 through a rectangular opening 45 in the middle of the sidewall 30D, and into the hot gas generator 43, where they are heated to approximately 1000 degrees Fahrenheit. These gases are heated using gaseous fuel, such as natural gas, which is supplied to the burners 42, to ignite and burn the gaseous fuel and to simultaneously heat the gases drawn from the volatizing chamber 30 in the hot gas generator 43. The recirculation fan 44 then directs the hot exhaust gases exiting the hot gas generator 43 into a set of cylindrical steel duct manifolds 48 positioned above the burners 42 and horizontally next to the top of the furnace 10 above the volatizing chamber 30. The manifolds 48 extend in a parallel fashion over the top of the volatizing chamber 30. A series of even smaller cylindrical steel ducts 50 extend from each of the ducts 48 downward into and through the top of the volatizing chamber 30, such that the hot exhaust gases are directed downward into the chamber 30 through the chamber ceiling 30C and onto the scrap aluminum A positioned below the ceiling 30C on the floor 34 of the chamber 30 in a recirculated fashion.

As can be seen from FIG. 3, a channel 52 running diagonally through the wall 30B connects the creek bed 40 to a second chamber 54 behind the wall 30B. This second chamber 54, having dimensions of approximately twenty feet wide and twenty feet long, is known as the “melt chamber” or “heating chamber” where the scrap aluminum A is fully melted and forms a pool of molten metal. A set of various gas fueled burners 56 direct heated exhaust gases through their associated cylindrical refractory ducts 58 into the heating chamber 54 to melt the aluminum in the chamber 54. The burners 56 help elevate the temperature in the heating chamber 54 to over 2,000 degrees Fahrenheit.

A channel 62, positioned at the bottom of a sidewall 64 of the heating chamber 54 provides a path for molten aluminum to exit the heating chamber 54 for removal from the furnace 10.

An optional vortex bowl system V having an inlet V1 and an outlet V2 (FIG. 3) is used in this representative furnace 10 to help circulate the molten metal from the heating chamber 54 and into the creek bed 40. Molten metal flows from the heating chamber 54, through the inlet V1, through the system V, out the outlet V2, and into the creek bed 40.

As can be appreciated, Applicant's aluminum recycling system or furnace 10 utilizes a multi-step process. First, bulk loads or bails of coated aluminum scrap A are fed into the furnace's coated scrap hearth or volatizing chamber 30 through the full-width hearth doorway 18 when the door 16 is in its raised or “OPEN” position. The burners 42 heat the hot gases to approximately 1000 Deg. F and the recirculation blower 44 forces these hot gases down upon the pile of coated scrap aluminum A positioned on the floor 34 of the volatizing chamber 30. These hot gases are introduced into the volatizing chamber 30 above the coated scrap aluminum A. As the scrap aluminum A moves from the doorway 18 to the creek bed 40 across the floor 34, the organics and other non-metal particulates (i.e., the “VOC's”) volatilize and are drawn into a vacuum hood 70 above the creek bed 40 for removal from the chamber 30.

After the VOC's have been removed from the scrap aluminum A in the volatizing chamber 30, the scrap aluminum is pushed into the creek bed 40, where it joins a flow of molten aluminum recirculating from the heating/melt chamber 54. The molten aluminum in the creek bed 40 circulates into the heating chamber 54 through the channel 52 in the rear sidewall 30B of the chamber 30. The molten aluminum then circulates out of the heating chamber 54, into the vortex bowl system V, and then back into the creek bed 40.

Referring now to FIGS. 4-7, a representative embodiment of the novel scrap metal push gate assembly 100 is shown positioned in proximity to the furnace 10's volatizing chamber 30. The push gate assembly 100 includes a steel or metal carriage 102, a steel or metal framework 104 positioned under the carriage 102, a roller glide 105 positioned between the carriage 102 and the framework 104, a metal plunger subassembly 106 positioned in the carriage 102 and directed toward the furnace 10, a generally flat metal door plate 108, a curved metal scrap scoop 110, and two hydraulic lock subsystems 112. The carriage 102 has a proximal end 116 and a distal end 118 opposite the proximal end. The carriage 102 is constructed of a flat, rectangular steel base 120, two matching vertical steel side panels 122 and 124 that extend perpendicularly upward from each of the long sides of the base 120, and a flat rectangular steel cover plate 125. The base 120 is approximately 40 feet long and 20 feet wide. The side panels 122 and 124 each have a height of approximately 5 feet along most of their length, and a height of approximately 10 feet near the proximal end 116 of the carriage 102.

The plunger subassembly 106 includes a cylindrical steel shaft 126 having a diameter of approximately one foot and a length of approximately thirty-five feet, a hydraulic piston 128 that houses the shaft 126, and a hydraulic pump 130 that powers the piston 128. The hydraulic pump 130 constitutes a force-producing mechanism. The shaft 126 and piston 128 are housed in and extend longitudinally through the middle of, and along nearly the full length of, the carriage 102. The shaft 126 extends snugly yet slidingly through an opening 127 near the center of the door plate 108, such that the shaft 126 can be controllably extended and retracted by the hydraulic piston 128 through the opening 127. The opening 127 can include a seal that is sized and shaped to limit the escape of heat and noxious gases from the volatizing chamber 30 through the opening 127. Sealing the plunger subassembly 106 also prevents “tramp air” from infiltrating from outside the furnace 10 into the volatizing chamber 30, which can otherwise undesirably cause the VOC's in the furnace 10 to combust. The hydraulic pump 130 operates the piston 128 to controllably urge the shaft 126 forward and backward along the length of the carriage 102.

The roller glide 105 includes a set of heavy-gage steel rollers 132 that span across the underside of the carriage 102 atop the framework 104 perpendicular to the plunger shaft 126. The rollers 132 support the carriage 102 atop the framework 104 and allow the carriage to be moved in a controllable manner forward and backward in the direction of the shaft 126.

A set of heavy gage steel rail wheels 134 are attached to the bottom of the framework 104 at each corner, and the wheels 134 are positioned atop a pair of parallel steel rails 136 secured to the floor near the furnace 10. The rails 136 run parallel to the face of the furnace doorway 18. The wheels 134 are shaped to mate to the rails 136, and oriented for the wheels 134 to roll atop and follow the direction of the rails 136. As can be seen and appreciated, the rails 136 extend under the carriage 102 from a first lateral position just in front of the doorway 18 (see FIGS. 4-13) to a second lateral position to the side of the doorway 18 (see FIGS. 14-17). The rails 136 enable the carriage 102 to be moved back and forth between the first lateral position in which the carriage 102 is oriented fully in front of the doorway 18 where the assembly 100 can operate properly to engage the furnace 10, and the second lateral position to the side of the furnace doorway 18 in which the carriage 102 is sufficiently removed from the furnace 10 to fully expose the doorway 18. Although the gate assembly 100 can be used in place of the gate 16, where in an alternate configuration the gate 16 is used in conjunction with the assembly 100, moving the carriage 102 to the side precludes the carriage 102 from obstructing the operation of the gate 16 to close and seal the doorway 18 and/or open away from the doorway 18.

Referring to FIGS. 4 and 17, it can be seen that each of the two hydraulic lock subsystems 112 positioned on opposite sides of the carriage 102 comprises a double-acting hydraulic piston 140, two sets of articulated pivoting latches 142 associated with each piston 140, a hydraulic pump (not shown) that provides fluid pressure to operate the pistons 140, and a series of hydraulic lines between the pump and pistons 140 (not shown). Each end of the piston 140 is operatively attached to one of the pair of latches 142. The pistons 140 are positionally secured to opposing outer surfaces of the side panel 122 and 124 near the front edge of the assembly 100 where they are matched with and controllably attach to their associated latches 142, which are also rotatably attached by center pivot pins (not shown) to the same side panels 122 and 124. The hydraulic pump provides hydraulic pressure through hydraulic lines to each of the pistons 140. In turn, the pistons 140 extend or retract to urge the proximal ends of the latches 142 upward or downward as may be desired to rotate their respective latching ends about the center pivot pins (not shown) so as to controllably force the latches to engage and/or disengage matching catches 144 positioned on the side of the furnace proximate the furnace doorway 18.

Thus, as can be appreciated, when the scrap metal push gate 100 is located at its first lateral position along the rails 136 in front of the furnace doorway 18, and the carriage 102 is moved forward on the roller glide 105 toward the doorway 18—all as shown in FIGS. 4-7—the hydraulic lock subsystem 112 may be operated to cause the latches 142 to engage their corresponding catches 144, and thereby releasably “lock” the carriage 102 to the doorway 18 and seal the door plate 108 against the doorway 18. The hydraulic lock subsystem 112 can be designed to operate manually, through a discrete computer control system (not shown), through a computer control system (not shown) that operates the entire scrap metal push gate 100, or through a master computer control system that also operates the furnace 10 (not shown).

Once the carriage 102 has been “locked” in place against the furnace doorway 18, the hydraulic pump 130 can be activated to operate the piston 128 to urge the shaft 126, and thereby the scrap scoop 110 inward toward the furnace 10 and into the volatizing chamber 30. As can be seen from FIGS. 4-7, the scrap scoop 110 is initially positioned flush against the door plate 108. From that starting position, the shaft 126 can push through the opening 127 in the door plate 108 to urge the scoop 110 to engage and then push the scrap metal A further into the volatizing chamber 30.

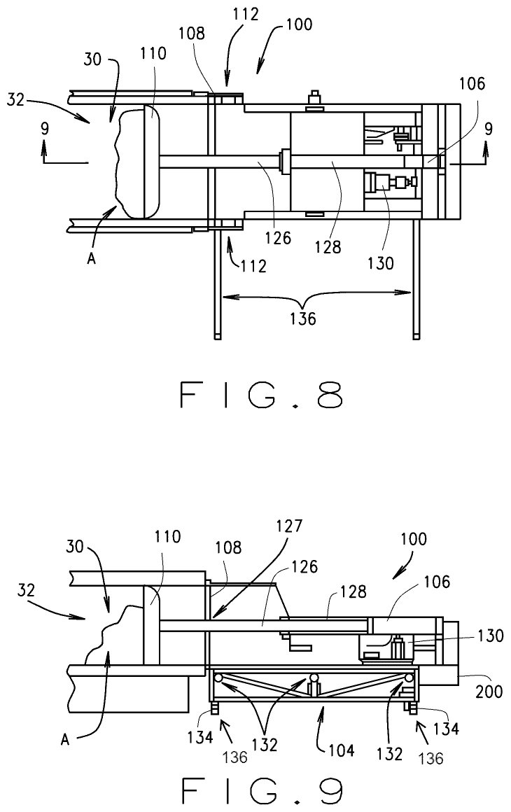

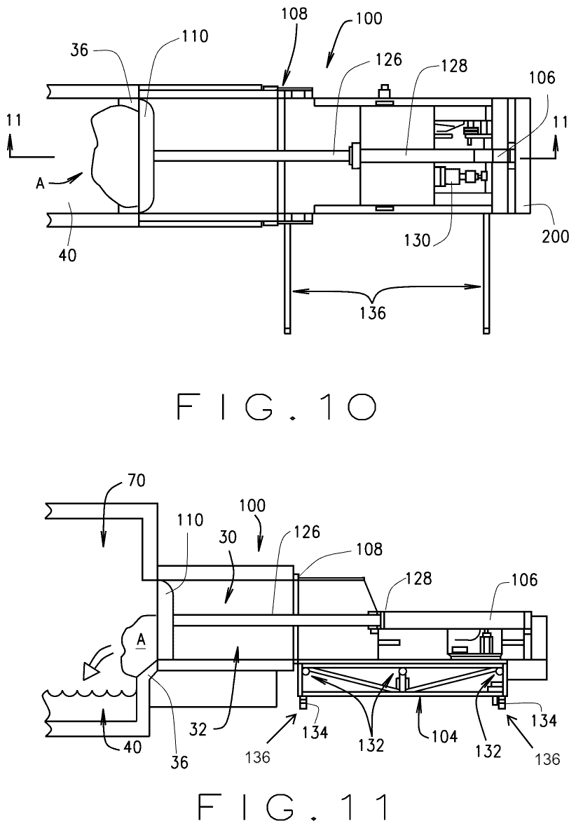

That is, the shaft 126 can controllably urge the scoop 110 to virtually any discrete position along the floor 34 of the volatizing chamber 30, from the door plate 108 against the doorway 18, to its most rearward position near the creek bed 40 where the shaft 126 is fully extended (as depicted in FIGS. 10 and 11), including for example, a generally central position, such as depicted in FIGS. 8 and 9. The push gate 100 can be designed to operate manually, through a discrete computer control system (not shown), through a computer control system (not shown) that operates the entire scrap metal push gate 100, or through a master computer control system that also operates the furnace 10 (not shown). Of course, one of ordinary skill in the art will recognize that the push gate 100 may be operated so as to urge the scrap scoop 110, and thereby the scrap A, to two or more desired positions or subzones along the floor 34 in the volatizing zone 32 for specified periods of time. Further, any of the optional computer control systems can be used to control the rate at which the scrap scoop 110, and thereby the scrap A, is urged through the different portions or subzones of the volatizing zone 32 in the volatizing chamber 30. Importantly, the scoop 110 can slowly urge the scrap A, which has been in the volatizing chamber 30 for a sufficient period of time (e.g., 45 minutes), into the creek bed 40 at a user-controllable steady and predictable rate. This prevents what is known as “slugging”, in which a large quantity of scrap Aluminum (e.g., 30,000 pounds) is dumped all at once into the creek bed 40. Such “slugging” is undesirable because it can result in irregularities, temperature variations, and even large clumps of un-melted metal in the metal melt flow as it circulates between the creek bed 40 and the heating chamber 54.

When it is desired to add another load or “charge” of scrap metal into the volatizing chamber 30 of the furnace 10, the hydraulic pump 130 can be controlled to operate the piston 128 to withdraw the shaft 126, and thereby the scrap scoop 110, outward from the interior of the volatizing chamber 30. Once the scoop 110 is positioned flush with the door plate 108, hydraulic pressure is supplied to each of the pistons 140 to retract and urge the proximal ends of the latches 142 upward to force the latch ends to disengage from their corresponding catches 144 proximate the furnace doorway 18. The carriage 102 can then be pulled away from the doorway 18 on the roller glide 105 to fully separate the push gate 100 from the furnace 10, and the entire push gate 100 can then be moved from the first lateral position as shown in FIGS. 4-13, to a different position along the rails 136 such as for example the second lateral position shown in FIGS. 14-17, so as to clear the furnace doorway 18 in preparation for adding another load or charge of scrap.

In addition, the carriage 120 comprises a counterweight 200 positioned near the distal end 118 of the carriage 102. The counterweight 200 provides balance to the push gate 100 when the shaft 126 is fully extended away from the carriage 102. Moreover, the push gate 100 includes a vertical lift subassembly 202 (see FIG. 5). The lift subassembly 202 allows the user to controllably raise and lower the carriage 102 to properly align the door plate 108 with the furnace doorway 118. The lift subassembly 202 can be designed to operate manually, through a discrete computer control system (not shown), through a computer control system (not shown) that operates the entire scrap metal push gate 100, or through a master computer control system that also operates the furnace 10 (not shown).

While I have described in the detailed description a configuration that may be encompassed within the disclosed embodiments of this invention, numerous other alternative configurations, that would now be apparent to one of ordinary skill in the art, may be designed and constructed within the bounds of our invention as set forth in the claims. Moreover, the above-described novel scrap metal push gate 100 for a metal recycle furnace 10 of the present invention can be arranged in a number of other and related varieties of configurations without expanding beyond the scope of my invention as set forth in the claims.

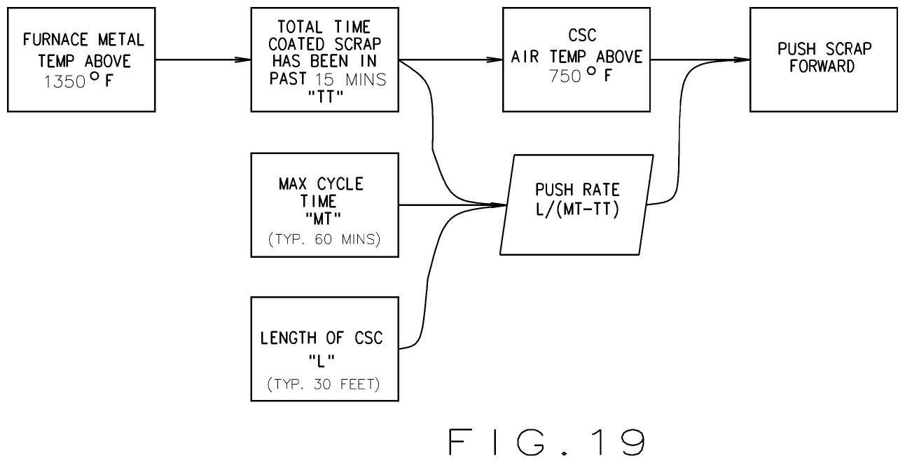

For example, it is contemplated by Applicant that the push gate 100 may incorporate a collection of sensors and/or switches (not shown) positioned in the furnace 10 that are connected to and operated by a computer control system (not shown). The computer control system, in turn, communicates with mechanical devices, such as for example the hydraulic pump 130 and the shaft 126, to automatically move the push scoop 110 forward and backward on the carriage 102 to one or more predetermined positions in the volatizing chamber 30, at one or more rates of travel, and for one or more predetermined periods of time. Thus, the computer control system can index the push scoop 110 into the volatizing chamber 30 of the furnace 10 in a predetermined and scheduled manner to ensure that the scrap, such as A, is volatized sufficiently before being pushed into the molten metal flow in the creek bed 40. A representative process flow chart is shown in FIG. 19 that depicts a process flow operated by a computer controller that controls the movement of the scoop 110 into the furnace 10 at a predetermined rate (i.e., “push rate”) based upon the length of the volatizing chamber 30 (i.e., the length between the doorway 18 and the creek bed 40) and time remaining in the process cycle.

Applicant further contemplates that various sensors and switches can be positioned in the furnace 10 so as to enable a computer control system to track the positioning and/or movement of the push scoop 110 and/or various bodies of scrap, such as for example the scrap A, positioned in the volatizing chamber 30. Pressure switches can be used to determine the amount of scrap positioned along the floor of the volatizing chamber 30. This information is electronically communicated to the computer control system, and the computer control system uses the data to ascertain how far to push the scrap scoop 110 into the furnace 10, and the timing and rate of such movement.

As one of ordinary skill in the art will recognize, such computer control systems can vary appreciably in configuration and capability. A representative computer control system may have, for example, a memory unit and a computer processor. The memory unit can store one or more computer codes for one or more desired process flows, along with various archival data and files. The computer processor can collect data from various sensors positioned in the furnace 10 and the assembly 100, and use that data in conjunction with the computer codes to instruct one or more force-producing mechanisms to controllably move the scoop 110 between two or more positions in the volatizing chamber 30 in accordance with the process flow.

In addition, the rails 136 can have different lengths than what is depicted in the Figures. For example, the rails 136 do not have to be the same length. The rails 136 can also be extended or shortened to any length that allows the assembly 100 to move to positions that enable the functioning of the assembly 100 as described herein. Moreover, other systems or devices can be used in place of the rails 136 and associated wheels 134—so long as such a system allows the assembly 100 to move to positions that enable the functioning of the assembly 100 as described herein. For example, the system may have no rails at all, but simply rely upon wheels or rollers or slides in place of the rails 136 and wheels 134.

By way of further example, the scoop 110 need not have the exact shape and size as represented in the Figures. In fact, the scoop 110 need not actually have a “scoop” shape. Rather, the scoop 110 may be larger, smaller, taller, shorter, deeper or shallower, or may be of any variety of other shapes—such as for example a flat plate—so long as the scoop 110 can be used as described in this disclosure.

Further, the mechanism that pushes the scoop 110 in and out of the furnace 10 is not limited to the metal plunger subassembly 106. Rather, any variety of devices and subassemblies, or combinations of various devices, all well known to one of ordinary skill in the art, may be employed as a plunger to move the scoop 110 beyond the plate 108, so long as the scoop 110 can be manipulated or controlled as described in this disclosure. Such devices or subassemblies may include, for example, geared drives, bushings, slides, motors, and/or windings, etc.

By way of further example, any of a variety of locking mechanisms may be used in place of one or more of the hydraulic lock subsystems 112—so long as such mechanisms can adequately secure the plate 108 to the furnace doorway 18 as described herein. Such locking mechanisms may include, for example, automated or non-automated hooks, levers, chains and/or screws.

In addition, any one or more of a variety of lift mechanisms may be used in place of the vertical lift subassembly 202—so long as such mechanisms can adequately raise and lower the carriage 102 as described herein. Such lift mechanisms may include, for example, automated or non-automated hydraulic piston systems, screws, chain lifts, and/or air lift devices.

It is also contemplated that any of the hydraulic pumps, such as the hydraulic pump 130 or the hydraulic pumps 140, can be replaced with any of a variety of mechanical force-producing mechanisms, devices and/or apparatuses—so long as such mechanisms, devices and/or apparatuses can properly operate in the assembly 100 as described herein.

As a further example, the roller glide 105 need not be configured with rollers or the exact number of rollers depicted, but may constructed in a variety of configurations, such as for example, a geared bed, a bed on bushings or bearings, or an air pillow, —so long as glide mechanisms can properly operate in place of the roller glide 105 in the assembly 100 as described herein.

Additional variations or modifications to the configuration of the above-described novel scrap metal push gate 100 for a metal recycle furnace 10 of the present invention may occur to those skilled in the art upon reviewing the subject matter of this invention. Such variations, if within the spirit of this disclosure, are intended to be encompassed within the scope of this invention. The description of the embodiments as set forth herein, and as shown in the drawings, is provided for illustrative purposes only and, unless otherwise expressly set forth, is not intended to limit the scope of the claims, which set forth the metes and bounds of my invention.

What is claimed is:

1. A push gate for a scrap metal melt furnace, said furnace having a volatizing chamber and a melt chamber, said volatizing chamber having a first process subzone and a second process subzone, said furnace having a metal melt flow extending at least in part between said volatizing chamber and said melt chamber, said furnace having a doorway opening into said volatizing chamber, said push gate comprising:
a. a door plate, said door plate sealing at least in part said doorway when said door plate is positioned against said doorway, said door plate having an opening there through;
b. a scoop, said scoop movable from a first position at which said scoop is proximate said door plate to a second position at which said scoop is separated from said door plate, said scoop being shaped and sized to fit within said volatizing chamber; and
c. a plunger, said plunger having a first end and a second end, said first end attaching to said scoop, said plunger first end controllably extending through said door plate opening into and retracting from said furnace volatizing chamber when said door plate is positioned against said doorway, said plunger first end urging said scoop between said scoop first and second positions.

2. The push gate of claim 1, wherein said plunger extends through said door plate, fits snugly into said door plate opening, and at least in part seals said opening.

3. The push gate of claim 2, further comprising a seal positioned in said door plate opening, said plunger extending through said seal, said seal sealing at least in part said opening.

4. The push gate of claim 1, wherein said plunger comprises a shaft, said shaft having a substantially uniform portion, said shaft uniform portion extending through said door plate opening.

5. The push gate of claim 1, further comprising a force-producing mechanism operatively associated with said plunger, said force-producing mechanism producing a mechanical force and applying said mechanical force to said plunger to controllably urge said plunger through said door plate opening.

6. The push gate of claim 5, wherein said force-producing mechanism comprises one of a hydraulic drive, a gaseous pressure drive and a mechanical drive, said drive producing said force.

7. The push gate of claim 5, further comprising a computer control system operatively associated with said force-producing mechanism, said computer control system having a memory unit, said memory unit storing a user programmable computer code for a desired process flow, said computer code instructing said force-producing mechanism to control said plunger to move said scoop between said first and second positions at one or more predetermined times in accordance with said process flow.

8. The push gate of claim 1, wherein, when said door plate is positioned against said furnace doorway, said scoop first position corresponds to a first location in said volatizing chamber first process subzone, and said scoop second position corresponds to a second location in said volatizing chamber second process subzone.

9. The push gate of claim 1, further comprising a fastener, said fastener releasably securing said door plate to said furnace doorway.

10. The push gate of claim 9, wherein said fastener comprises one of a rotating lock, a lock-pin, a latch, a hook, a clamp and a screw.

11. The push gate of claim 1, further comprising a carriage, said carriage having a proximal end and a distal end, said carriage supporting at least in part said plunger, said plunger first end being oriented proximate said carriage proximal end, said carriage being movable from a first position in which said door plate is proximate said furnace doorway to a second position in which said door plate is not proximate said furnace doorway.

12. The push gate of claim 11, wherein said carriage comprises a glide, said door plate being attached to said glide, said glide moving said door plate between a forward position and a rearward position in said carriage.

13. The push gate of claim 1, further comprising a lift, said lift controllably raising and lowering said push gate.

14. The push gate of claim 1, further comprising a counterweight, said counterweight positioned opposite said plunger first end, said counterweight having a weight, said weight being sufficient to preclude said push gate proximal end from tipping downward when said plunger is extended.

15. A push gate for a scrap metal melt furnace, said furnace having a volatizing chamber and a melt chamber, said volatizing chamber having a first process subzone and a second process subzone, said furnace having a metal melt flow extending at least in part between said volatizing chamber and said melt chamber, said furnace having a doorway opening into said volatizing chamber, said push gate comprising:
a. a carriage, said carriage having a proximal end and a distal end, said carriage being movable from a first position in which said proximal end is proximate said furnace doorway to a second position in which said proximal end is not proximate said furnace doorway.
b. a door plate supported by said carriage and positioned proximate said carriage proximal end, said door plate sealing at least in part said doorway when said carriage is in said first position, said door plate having an opening there through;
c. a scoop supported by said carriage, said scoop being movable from a first position at which said scoop is proximate said door plate to a second position at which said scoop is separated from said door plate, said scoop being shaped and sized to fit within said volatizing chamber; and
d. a plunger supported by said carriage, said plunger having a first end and a second end, said plunger first end being oriented proximate said carriage proximal end and attaching to said scoop, said plunger first end controllably extending through said door plate opening into and out of said furnace volatizing chamber when said door plate is positioned against said doorway, said plunger first end urging said scoop between said scoop first and second positions.

16. The push gate of claim 15, further comprising a glide, said door plate being attached to said glide, said glide moving said door plate between a forward position and a rearward position in said carriage,

17. The push gate of claim 15, further comprising a force-producing mechanism operatively associated with said plunger, said force-producing mechanism producing a mechanical force and applying said mechanical force to said plunger to controllably urge said plunger through said door plate opening.

18. The push gate of claim 17, further comprising a computer control system operatively associated with said force-producing mechanism, said computer control system having a memory unit, said memory unit storing a user programmable computer code for a desired process flow, said computer code instructing said force-producing mechanism to control said plunger to move said scoop between said first and second positions at one or more predetermined times in accordance with said process flow.

19. The push gate of claim 15, wherein, when said door plate is positioned against said furnace doorway, said scoop first position corresponds to a first location in said volatizing chamber first process subzone, and said scoop second position corresponds to a second location in said volatizing chamber second process subzone.

20. The push gate of claim 15, further comprising a lift, said lift controllably raising and lowering said push gate.
